(19) United States
(12) Patent Application Publication
(10) Pub. No.: US 2015/0199572 A1
(43) Pub. Date: Jul. 16, 2015

(54) OBJECT TRACKING USING OCCLUDING CONTOURS

(71) Applicant: QUALCOMM Incorporated, San Diego, CA (US)

(72) Inventors: Kiyoung Kim, Vienna (AT); Yanghai Tsin, Palo Alto, CA (US)

(73) Assignee: QUALCOMM Incorporated, San Diego, CA (US)

(21) Appl. No.: 14/157,110

(22) Filed: Jan. 16, 2014

(51) Int. Cl. G06K 9/00; G06K 9/48; G06K 9/46

(52) U.S. Cl. CPC G06K 9/00624; G06K 9/4604; G06K 9/48

(57) ABSTRACT

Embodiments disclosed pertain to object tracking based, in part, on occluding contours associated with the tracked object. In some embodiments, a 6 Degrees of Freedom (6-DoF) initial camera pose relative to a tracked object in a first image may be obtained. A 6-DoF updated camera pose relative to the tracked object for a second image subsequent to the first image may then be obtained based, at least, on the initial camera pose and one or more features associated with the tracked object and an occluding contour associated with the tracked object in the second image. The occluding contour associated with the tracked object in the second image may be derived from a closed form function.

### FIELD

This disclosure relates generally to apparatus, systems, and methods for object tracking, and in particular, to object tracking using occluding contours.

### BACKGROUND

In Augmented Reality (AR) applications, which may be real-time interactive, real images may be processed to add virtual object(s) to the image and to align the virtual object to a captured image three dimensions (3D). Therefore, determining the objects present in real images as well as the location of those objects may facilitate effective operation of many AR systems and may be used to aid virtual object placement.

In AR, detection refers to the process of localizing a target object in a captured image frame and computing a camera pose with respect to the object. Tracking refers to camera pose estimation relative to the object over a temporal sequence of image frames. In feature-based tracking, for example, stored point features may be matched with features in a current image to estimate camera pose. For example, feature-based tracking may compare a current and prior image and/or the current image with one or more registered reference images to update and/or estimate camera pose.

However, there are several situations where conventional feature-based tracking may not perform adequately. For example, conventional methods may perform sub-optimally when tracking objects with relatively little surface texture. Further, conventional feature-based approaches may artificially constrain or require a prior knowledge of camera motion relative to the tracked object and/or make other simplifying assumptions that detrimentally affect tracking accuracy.

Therefore, there is a need for apparatus, systems and methods to enhance feature-based tracking approaches to achieve tracking accuracy in 6-DoF for a more optimal user experience.

### SUMMARY

In some embodiments, a method may comprise: obtaining a 6 Degrees of Freedom (6-DoF) initial camera pose relative to a tracked object in a first image; and determining a 6-DoF updated camera pose relative to the tracked object for a second image subsequent to the first image, the 6-DoF updated camera pose being determined based, at least, on the initial camera pose, an occluding contour associated with the tracked object in the second image and features associated with the tracked object, wherein the occluding contour associated with the tracked object in the second image is derived from a closed form function.

In another aspect, a Mobile Station (MS) may comprise: a camera configured to capture a sequence of images comprising a first image and a second image captured subsequent to the first image; and a processor coupled to the camera. In some embodiments, the processor may be configured to: obtain a 6 Degrees of Freedom (6-DoF) initial camera pose relative to a tracked object in the first image, and determine, a 6-DoF updated camera pose relative to the tracked object for the second image, the 6-DoF updated camera pose being determined based, at least, on the initial camera pose, an occluding contour associated with the tracked object in the second image and features associated with the tracked object, wherein the occluding contour associated with the tracked object in the second image is derived from a closed form function.

In a further aspect, an apparatus may comprise: means for obtaining a sequence of images comprising a first image and a second image captured subsequent to the first image; means for obtaining a 6 Degrees of Freedom (6-DoF) initial camera pose relative to a tracked object in the first image, and means for determining a 6-DoF updated camera pose relative to the tracked object for the second image, the 6-DoF updated camera pose being determined based, at least, on the initial camera pose, an occluding contour associated with the tracked object in the second image, and features associated with the tracked object, wherein the occluding contour associated with the tracked object in the second image is derived from a closed form function.

Further, in some embodiments, a non-transitory computer-readable medium may comprise instructions, which when executed by a processor, perform steps in a method, where the steps may comprise: obtaining a 6 Degrees of Freedom (6-DoF) initial camera pose relative to a tracked object in a first image; and determining a 6-DoF updated camera pose relative to the tracked object for a second image subsequent to the first image, the 6-DoF updated camera pose being determined based, at least, on the initial camera pose, an occluding contour associated with the tracked object in the second image and features associated with the tracked object, wherein the occluding contour associated with the tracked object in the second image is derived from a closed form function.

### BRIEF DESCRIPTION OF THE DRAWINGS

Embodiments of the invention will be described, by way of example only, with reference to the drawings.

FIG. 1 shows a block diagram of an exemplary mobile device capable of implementing feature based tracking in a manner consistent with disclosed embodiments.

FIG. 2A shows a portion of the 2D occluding contours associated with a variety of everyday objects.

FIGS. 2B and 2C illustrate two views of an object for which a CG has been determined.

FIG. 3A shows a flowchart for an exemplary method for tracking using occluding contours in a manner consistent with disclosed embodiments.

FIG. 3B shows an exemplary conical section.

FIG. 3C is a visual depiction of the application of an exemplary method for the detection of occluding contours for conical section 400.

FIG. 3D shows an application of an exemplary method for computing pose updates using occluding contours for object 220 that may be represented by a closed form function.

FIG. 4 shows a flowchart for an exemplary method for computing pose updates using occluding contours in a manner consistent with disclosed embodiments.

FIG. 5 shows a schematic block diagram illustrating a computing device enabled to facilitate the computation of pose updates using occluding contours in a manner consistent with disclosed embodiments.

### DETAILED DESCRIPTION

In feature-based visual tracking, local features are tracked across an image sequence. However, there are several situations where feature based tracking may not perform adequately. Feature-based tracking methods may not reliably estimate camera pose in situations where tracked objects lack adequate texture. For example, in some objects printed features on object surfaces may be weak or ambiguous and insufficient for robust feature-based visual tracking. As another example, even when product packaging exhibits texture, the textured portions may be limited to a relatively small area of the packaging thereby limiting the utility of the textured sections during visual tracking. Therefore, some embodiments disclosed herein apply computer vision and other image processing techniques to improve tracking accuracy and determine camera pose in 6-DoF for a variety of 3D geometric shapes using occluding contours thereby enhancing user AR experience. In some embodiments, the 3D geometric shapes may comprise various classes of objects that may be of interest to augmented reality application developers and may include soda cans, coffee or beverage cups, bottles, cereal cartons, boxes, etc.

These and other embodiments are further explained below with respect to the following figures. It is understood that other aspects will become readily apparent to those skilled in the art from the following detailed description, wherein it is shown and described various aspects by way of illustration. The drawings and detailed description are to be regarded as illustrative in nature and not as restrictive.

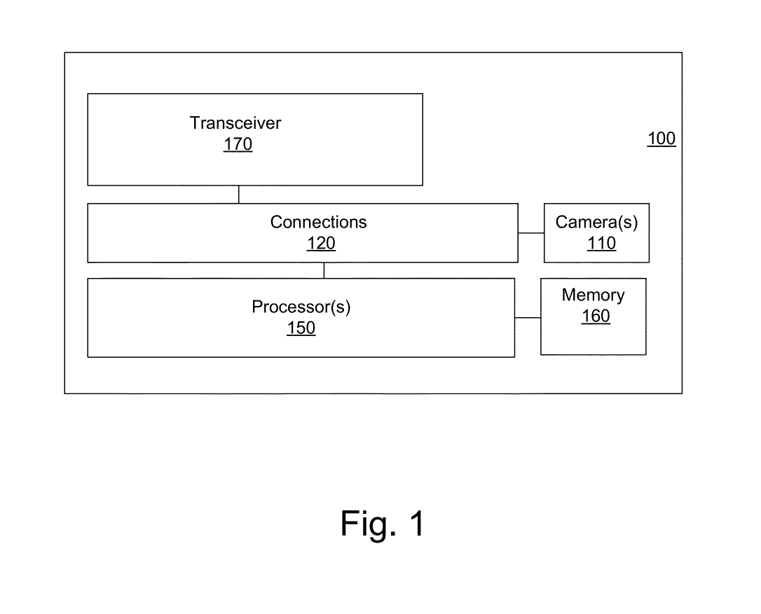

FIG. 1 shows a block diagram of an exemplary Mobile Station (MS) 100 capable of running one or more AR applications, which, in some instances, may use visual feature-based tracking methods. In some embodiments, MS 100 may be capable of implementing AR methods based on an existing 3-Dimensional (3D) model of an environment. In some embodiments, the AR methods, which may include tracking in 6-DoF, may be implemented in real time or near real time using live images in a manner consistent with disclosed embodiments. As shown in FIG. 1, MS 100 may include cameras 110, processors 150, memory 160 and/or transceiver 170, which may be operatively coupled to each other and to other functional units (not shown) on MS 110 through connections 120. Connections 120 may comprise buses, lines, fibers, links, etc., or some combination thereof.

Transceiver 170 may, for example, include a transmitter enabled to transmit one or more signals over one or more types of wireless communication networks and a receiver to receive one or more signals transmitted over the one or more types of wireless communication networks. Transceiver 170 may permit communication with wireless networks based on a variety of technologies such as, but not limited to, femtocells, Wi-Fi networks or Wireless Local Area Networks (WLANs), which may be based on the IEEE 802.11 family of standards, Wireless Personal Area Networks (WPANS) such Bluetooth, Near Field Communication (NFC), networks based on the IEEE 802.15x family of standards, etc, and/or Wireless Wide Area Networks (WWANs) such as LTE, WiMAX, etc. Mobile device may also include one or more ports for communicating over wired networks.

In some embodiments, cameras 110 may include multiple cameras, front and/or rear-facing cameras, wide-angle cameras, and may also incorporate CCD, CMOS, and/or other sensors. Camera(s) 110, which may be still or video cameras, may capture a series of image frames of an environment and send the captured image frames to processor 150. In one embodiment, images captured by cameras 110 may be in a raw uncompressed format and may be compressed prior to being processed and/or stored in memory 160. In some embodiments, image compression may be performed by processors 150 using lossless or lossy compression techniques. In some embodiments, cameras 110 may be stereoscopic cameras capable of capturing 3D images. In another embodiment, camera 110 may include depth sensors that are capable of estimating depth information. In some embodiments, disclosed methods for object tracking using occluding contours may be performed in real time using live images captured by camera(s) 110.

Processors 150 may also execute software to process image frames captured by camera 110. For example, processor 150 may be capable of processing one or more image frames captured by camera 110 to perform visual tracking including through the use of occluding contours, determine the pose of camera 110 and/or to perform various other Computer Vision (CV) methods. The pose of camera 110 refers to the position and orientation of the camera 110 relative to a frame of reference. In some embodiments, camera pose may be determined for 6-Degrees Of Freedom (6DOF), which refers to three translation components (which may be given by X,Y,Z coordinates) and three angular components (e.g. roll, pitch and yaw). In some embodiments, the pose of camera 110 and/or MS 100 may be determined and/or tracked by processor 150 using a visual tracking solution that comprises the use of occluding contours detected in live image frames captured by camera 110 in a manner consistent with disclosed embodiments.

Processors 150 may be implemented using a combination of hardware, firmware, and software. Processors 150 may represent one or more circuits configurable to perform at least a portion of a computing procedure or process related to 3D reconstruction, SLAM, object tracking, modeling, image processing etc and may retrieve instructions and/or data from memory 160. Processors 150 may be implemented using one or more application specific integrated circuits (ASICs), central and/or graphical processing units (CPUs and/or GPUs), digital signal processors (DSPs), digital signal processing devices (DSPDs), programmable logic devices (PLDs), field programmable gate arrays (FPGAs), controllers, micro-controllers, microprocessors, embedded processor cores, electronic devices, other electronic units designed to perform the functions described herein, or a combination thereof.

Memory 160 may be implemented within processors 150 and/or external to processors 150. As used herein the term “memory” refers to any type of long term, short term, volatile, nonvolatile, or other memory and is not to be limited to any particular type of memory or number of memories, or type of physical media upon which memory is stored. In some embodiments, memory 160 may hold code to facilitate image processing, perform object tracking, modeling, 3D reconstruction, camera pose determination in 6-DoF, and/or other tasks performed by processor 150. For example, memory 160 may hold data, captured still images, 3D models, depth information, video frames, program results, as well as data provided by various sensors. In general, memory 160 may represent any data storage mechanism. Memory 160 may include, for example, a primary memory and/or a secondary memory. Primary memory may include, for example, a random access memory, read only memory, etc. While illustrated in FIG. 1 as being separate from processors 150, it should be understood that all or part of a primary memory may be provided within or otherwise co-located and/or coupled to processors 150.

Secondary memory may include, for example, the same or similar type of memory as primary memory and/or one or more data storage devices or systems, such as, for example, flash/USB memory drives, memory card drives, disk drives, optical disc drives, tape drives, solid state drives, hybrid drives etc. In certain implementations, secondary memory may be operatively receptive of, or otherwise configurable to couple to a non-transitory computer-readable medium in a removable media drive (not shown) coupled to mobile device 100. In some embodiments, computer readable medium may form part of memory 160 and/or processor 150.

Not all modules comprised in mobile device 100 have been shown in FIG. 1. Exemplary mobile device 100 may also be modified in various ways in a manner consistent with the disclosure, such as, by adding, combining, or omitting one or more of the functional blocks shown. For example, in some configurations, MS 100 may not include Transceiver 170 and may operate as a standalone device capable of running image processing, computer vision and/or AR applications.

Further, in certain example implementations, mobile device 100 may include an IMU, which may comprise 3-axis gyroscope(s), and/or magnetometer(s). IMU may provide velocity, orientation, and/or other position related information to processor 150. In some embodiments, IMU may output measured information in synchronization with the capture of each image frame by cameras 130. In some embodiments, the output of IMU may be used in part by processor 150 to determine, correct, and/or otherwise adjust the estimated pose of camera 110 and/or MS 100. Further, in some embodiments, images captured by cameras 110 may also be used to recalibrate or perform bias adjustments for the IMU. In some embodiments, MS 100 may comprise a Satellite Positioning System (SPS) unit, which may be used to provide location information to MS 100.

In some embodiments, MS 100 may comprise a variety of other sensors such as stereo cameras, ambient light sensors, microphones, acoustic sensors, ultrasonic sensors, laser range finders, etc. In some embodiments, portions of mobile device 100 may take the form of one or more chipsets, and/or the like. Further, MS 100 may include a screen or display (not shown) capable of rendering color images, including 3D images. In some embodiments, MS 110 may comprise ports to permit the display of the 3D reconstructed images through a separate monitor coupled to MS 100. MS 100. In some embodiments, the display may be housed separately from MS and may be optical head-mounted display. In some embodiments, MS 100 may take the form of a wearable computing device.

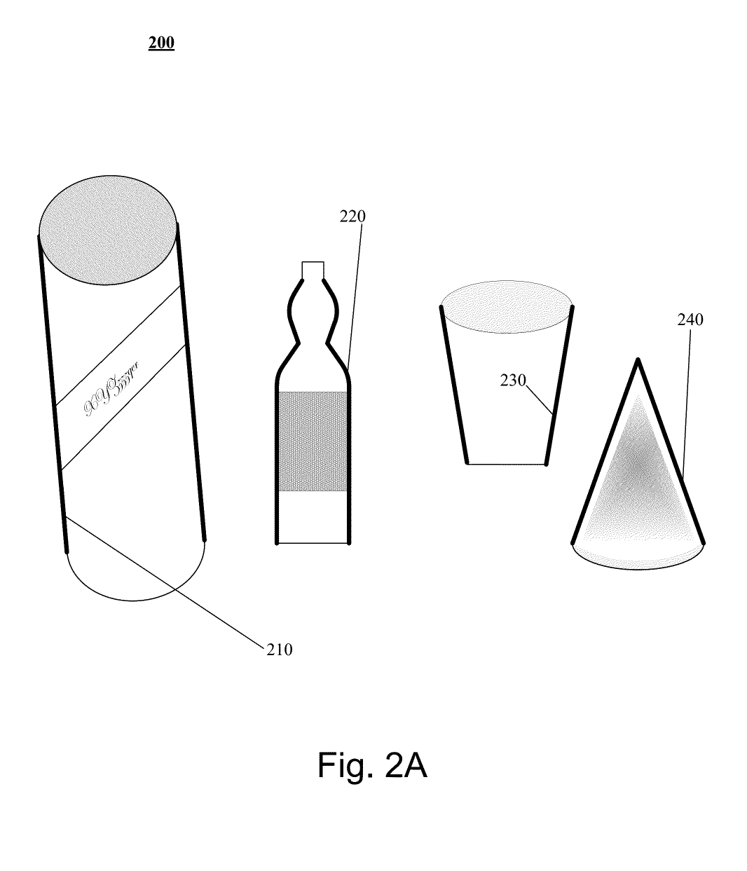

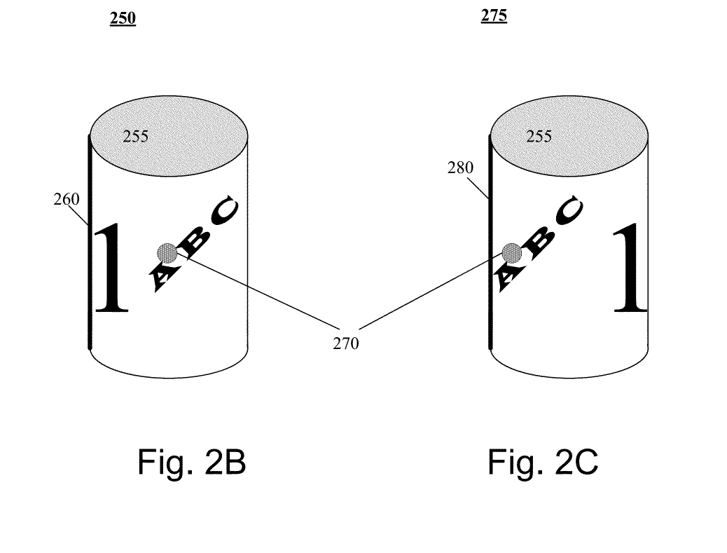

FIG. 2A shows a diagram 200 illustrating some exemplary occluding contours associated with a variety of everyday objects. Occluding contours are shown in FIG. 2A with dark heavy lines. The term “3D occluding contour” is used herein to refer to the extremal boundary, or a portion thereof, of a 3D object. The “3D occluding contour” may be a profile, or a set of profiles with shape information for a 3D object. A profile is a general curve on a plane. The 3D occluding contour may thus be viewed as a smooth space curve on the surface of a bounded object where viewing rays touch the object. At every point along the occluding contour, the surface normal is orthogonal to the viewing ray.

The image of the occluding contour is an image curve, which is also called a silhouette or apparent contour. A “critical set” of points may thus be defined for each camera position relative to a smooth surface of an object, where, for each point in the critical set, the visual ray from the camera center to the point is tangent to the surface. The critical set is also known as the “contour generator” (CG) or the rim. The CG may be viewed as a 3D smooth curve that separates the visible and invisible part of a smooth object. The 2D occluding contour for the object is the 2D projection of the CG for the object on the image plane. The contour generator is thus the set of points on the surface that generates the 2D occluding contours observed in an image. From a perspective camera located at C=[Cₓ, C_{y}, C_{z}]^{T}, where the superscript ^{“T”} denotes the transpose of a matrix, the contour generator is thus defined as

CG(C)={X|n^{T}(X−C)=0, X∈ S} (1)

where S is the set of all points on the surface. Equation (1) states that the set of viewing rays X−C passing through the points X on the contour generator is perpendicular to the surface normal at X.

FIG. 2A shows a portion of the 2D occluding contour for a cylindrical object 210, 2D occluding contour for a bottle 220, 2D occluding contour for a cup or conical section 230, and 2D occluding contour for a cone 240. The portions of the 2D occluding contours for objects 210-240 are illustrated in FIG. 2A using heavy lines. In some embodiments, occluding contours (such as occluding contours for objects 210, 220, 230 and/or 240) may be used to improve tracking robustness. For example, feature points on the objects in FIG. 2A shown may be limited. Therefore, in some instances, the occluding contours may represent a dominant feature of the objects. Thus, when conventional feature-based techniques for object tracking are used to track objects with a limited number of distinctive feature points, the tracking methods may yield sub-optimal results because of the relative paucity of feature points.

On the other hand, techniques based solely on the use of occluding contours may also yield less than optimal results because the occluding contour is view dependent. In other words, because the critical set which generates the occluding contour for smooth surfaces is different for each view, triangulation using two image frames will not yield correct results along the occluding contour.

FIGS. 2B and 2C illustrate two views of an object for which a CG has been determined. As shown in FIG. 2B, in view 250, object 255 has CG 260. Further, Point 270 on object 255 may be seen as having fixed coordinates relative to an object reference frame. In other words, Point 270 is at a fixed location on object 255.

In FIG. 2C, in view 275, the camera pose relative to object 255 has changed, and object 255 now has CG 280. However, in view 275, point 270 on the object 255 has moved relative to CG 280. This is because CG 280 comprises a different set of points than CG 260. In general, as the camera changes pose, the occluding contour will move over the surface. Thus, an image silhouette initially due to some point p on CG 260 (in FIG. 2B) may, in FIG. 2C, be due to another point q in CG 280. Thus, triangulation using the image frames corresponding to views 250 and 275 will not yield correct results along the occluding contour. Because occluding contours are merely general planar curves which lack distinguishing feature points, establishing feature point correspondence across views based solely on the occluding contours can be error prone. Accurate tracking may be facilitated by establishing a relationship between q, p and the pose change.

In conventional schemes that attempt to combine feature tracking with the use of occluding contours a priori knowledge of the curvatures for all points as well as the axis of rotation of the object relative to the global coordinate system is often required. Therefore, conventional methods that require knowledge of the axis of rotation are effectively tracking objects only with 4 Degrees of Freedom. Further when performing object tracking using live video images, or random scenes, obtaining information about the axis of rotation of the object relative to the global coordinate system or imposing other constraints may be impractical. Other simplifications, constraints, restrictions, or a priori knowledge requirements pertaining to tracked objects and/or camera motion relative to tracked objects limit the applicability of tracking methods in real world situations and/or result in inaccuracies in pose computations.

Moreover, other conventional tracking methods may also fail when there is relative motion between the camera and the tracked object because the CG may gradually “slip” or “glide” along the smooth surface. For example, the use of edge correspondence techniques such as Natural Features Tracking with Normalized Cross Correlating (NCC) patch matching will not correctly detect occluding contours because: 1) the occluding contour will straddle a portion of the target and a portion of the background; 2) the affine warping for the patch may be undefined because the surface normal at the CG is perpendicular to the viewing ray direction, and 3) the anchor points in 3D are different from different viewing angles.

Therefore, some embodiments disclosed herein apply computer vision and other image processing techniques to estimate 6-DoF camera pose with respect to a target by using model-based 3D tracking of the camera/target. Disclosed techniques improve tracking accuracy and determine a camera pose in 6-DoF for a variety of 3D geometric shapes, in part, by using occluding contours. Embodiments disclosed herein also facilitate object tracking with full 6-DoF using live camera images in real time. In some embodiments disclosed herein feature-based tracking techniques are combined with the use of closed form update functions for occluding contours to robustly track objects. The term “closed form function” refers to a mathematical function that is expressible in terms of elementary or well-known functions, which may be combined using a finite number of rational operations and compositions.

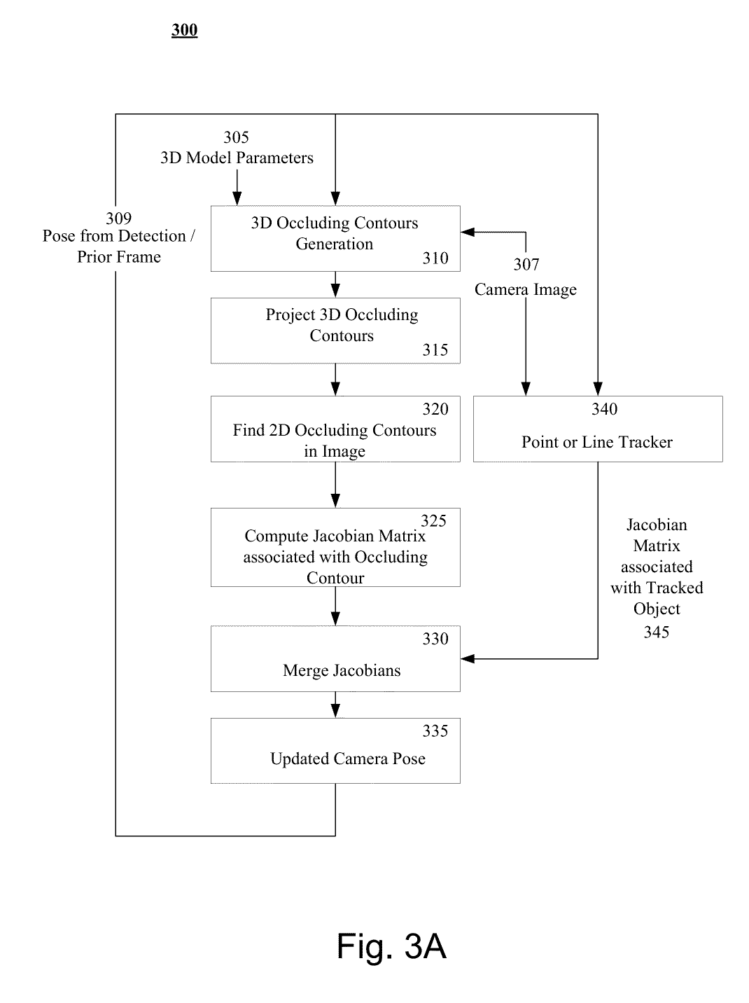

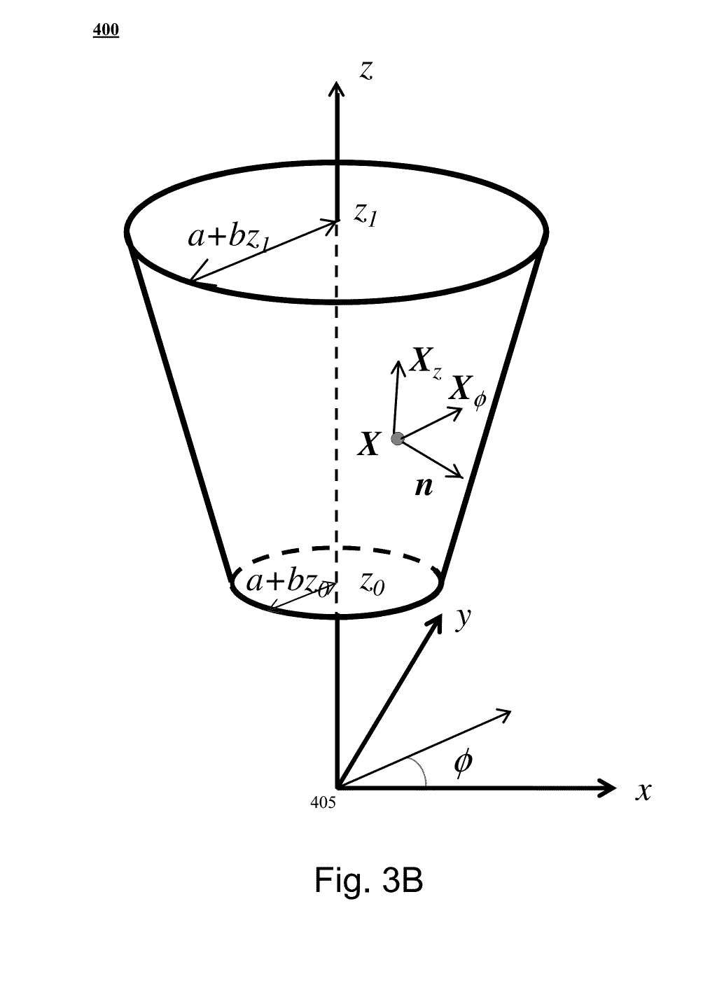

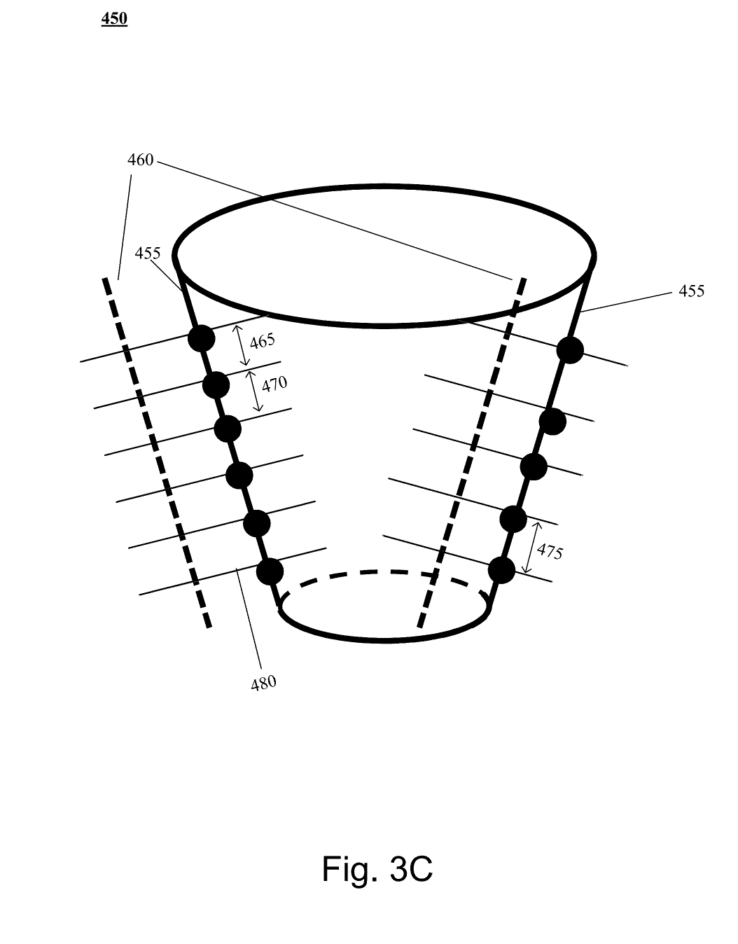

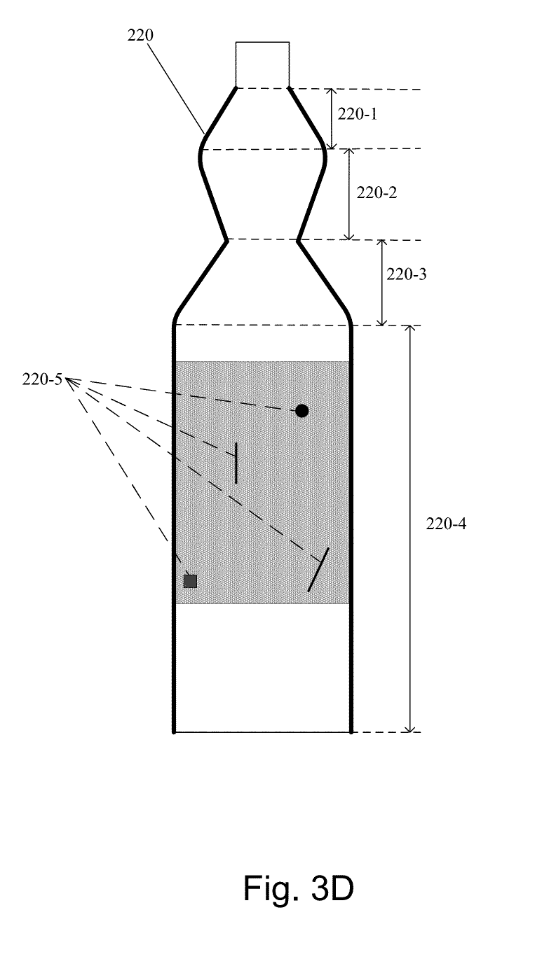

FIG. 3A shows a flowchart for an exemplary method 300 for computing pose updates using occluding contours. In some embodiments, method 300 may be applied to track objects that may be described using closed form functions. In the present description, by way of example, method 300 is applied to a conical section shown in FIG. 3B, which is represented by a closed form function. Conical sections encompass a class of objects that are of interest to the AR community. The objects include soda cans, various types of cups (e.g. coffee cups), bottles, vases, flower pots, etc.

FIG. 3B shows an exemplary conical section 400, which, for ease of description, is shown with its axis aligned with the z-axis of a global frame of reference 405 given by x, y, and z axes. In general, exemplary conical section may be arbitrarily oriented relative to the camera. As shown in FIG. 3B, the conical section is cut off using two horizontal planes, which are parallel to the x-y plane and located at coordinates z₀ and z₁ on the x-axis. In general, conical section 400 may be arbitrarily located and/or aligned relative to the global frame of reference. X_{φ} and X_{z} are the partial derivatives of X with respect to polar coordinates (φ, z), so that the normal vector of X is the cross-product of X_{φ} and X_{z}.

Referring to FIG. 3A, in step 310, 3D occluding contours may be generated using 3D model parameters 305 and a current camera image frame 307 captured by camera 110. From equation (1), the contour generator is CG(C)={X|n^{T}(X−C)=0, X∈ S}, where S is the set of all points on the surface and n^{T} is normal vector of X on that surface. An initial estimate of the pose 309 for current image frame is obtained as the estimated pose 309 from the previous frame. In some embodiments, for the first frame a pose may be assumed, or obtained using a motion model.

For example, in mathematical terms, for the exemplary conical section 400 in FIG. 3B, which comprises the smooth surface in between the two cutting planes may be defined in terms of polar coordinates (φ, z) as

X(φ, z)=[(a+bz)cosφ, (a+bz)sinφ, z], z∈(z₀,z₁). (2)

where φ is the angular displacement of a point relative to the x-axis as shown in FIG. 3B.

From Equation (1), the set of viewing rays X−C passing through the points X on contour generator is perpendicular to the surface normal at X. From a camera located at C=[Cₓ, C_{y}, C_{z}]^{T}, for the conical section 400, this may be expressed as

$$[ cos φ , sin φ , - b ] ( [ \begin{matrix}( a + bz ) cos φ \\ ( a + bz ) sin φ \\ z\end{matrix} ] - [ \begin{matrix}{C}_{x} \\ {C}_{y} \\ {C}_{z}\end{matrix} ] ) = 0.$$

Accordingly, the contour generator for exemplary conical section 400 may be written in the form

$$\begin{matrix}[ ( a + bz ) cos {φ}_{i} , ( a + bz ) sin {φ}_{i} , z ) , i = 1 , 2. \\ where , & ( 3 ) \\ {φ}_{1} = θ + arccos \frac{a + {C}_{z} b}{d} and {φ}_{2} = θ - arccos \frac{a + {C}_{z} b}{d} , & ( 4 ) \\ θ = arctan ( \frac{{C}_{y}}{d} , \frac{{C}_{x}}{d} ) , & ( 5 ) \\ d = \sqrt{{C}_{x}^{2} + {C}_{y}^{2}} & ( 6 ) \\ cos {φ}_{i} = \frac{1}{{C}_{x}^{2} + {C}_{y}^{2}} ( {C}_{x} ( a + {C}_{z} b ) ∓ {C}_{y} \sqrt{{C}_{x}^{2} + {C}_{y}^{2} - {( a + {C}_{z} b )}^{2}} ) & ( 7 ) \\ sin {φ}_{i} = \frac{1}{{C}_{x}^{2} + {C}_{y}^{2}} ( {C}_{y} ( a + {C}_{z} b ) \pm {C}_{x} \sqrt{{C}_{x}^{2} + {C}_{y}^{2} - {( a + {C}_{z} b )}^{2}} ) & ( 8 )\end{matrix}$$

Next, in step 315, the generated 3D occluding contour from step 310 is projected on to the image plane. For example, based on the previous pose, and/or motion sensors, the 3D occluding contours may be projected onto the image plane. In some embodiments, all points X on the 3D occluding contour may be projected on the image plane. In another embodiment, a selected sample of points X on the 3D occluding contour may be projected onto image plane. In some embodiments, the number of samples of points X projected onto the 3D occluding contour may be varied based on system parameters. For example, the response time, accuracy desired, processing power available, and/or other system parameters may be used to determine the number of points projected. In some embodiments, projected 3D occluding contour points that fall outside the image border may be discarded.

Next, in step 320, the 2D Occluding Contours in the current image are determined. In some embodiments, input camera image frame may be filtered and downsampled to create a pyramid of images of different resolutions and the actual positions of occluding contours may be determined using the image pyramid. For example, in some embodiments, using the image pyramid, areas around visible projected X points may be searched along the normal direction in the image plane to determine the 2D occluding contour.

In some embodiments, all pixels with a magnitude above some threshold in a neighborhood around a projected contour point X may be selected and curve fitting may be applied to the selected candidate pixels using the known closed form occluding contour function f(X) to determine points that lie on the 2D occluding contour. For example, equation (3) above may be used for curve fitting for one of the exemplary conics shown in FIG. 2 (such as objects 210, 230 and/or 240) when determining the occluding contour.

FIG. 3C is a visual depiction of the application of an exemplary method 450 for the detection of occluding contours for conical section 400. In some embodiments, edges may be detected around the projected contour. For example, for object 400, the neighborhood around projected occluding contour 455 in the image may be sampled for straight lines. In some embodiments, projected occluding contour 455 may be split into exemplary small line segments 465, 470 and 475 as shown.

In some embodiments, Hough transforms may be used to detect edges around the projected 2D occluding contour by searching for edge candidates along normal direction 480. Edge candidates vote for the line equations using Hough transform. Typically, because inter-frame motion is small and/or due to any active image alignment that may be performed, the target is typically roughly aligned with the projection. Therefore, in some embodiments, a relatively small angular range around the normal direction may be searched for candidate edges.

In some embodiments, edge candidates may vote based on the angular difference (Δα) between the projected occluding contour direction and the measured edge direction. Because this angular difference is typically small, sin(Δα)≈Δα. Thus, sin(Δα) can be computed by projecting the measured edge normal direction onto the tangent direction of the occluding contour t, where t^{T}n=0 and n is occluding contour normal direction. Similarly, intercept bins may be limited based on the displacement range. In some embodiments, intercept bins may take the form of a 2D array comprising the (relative) angle (Δα) and the (relative) distance relative to the projected occluding contour. For example, the relative angle i and the relative distance j are computed for each neighbor pixel along the projected 2D occluding contour and the 2D array at (i, j) is voted on. In some embodiments, a 2D array position with the largest number of votes may be selected and the (i, j) value for that position is used as the relative angle and the relative distance.

Each candidate edge pixel is characterized by a location and an angle. In some embodiments, each edge pixel may be used as an edgel for voting. Accordingly, each edgel may vote for a point in the line in Hough space. The angle of the candidate edge pixel can be measured by applying a Sobel filter. Sobel filters may be used to determine both the magnitude of the gradient or change in brightness associated with the edge pixel and orientation of the edge pixel.

In some embodiments, image coordinates may be undistorted before voting. For example, with wide angle cameras or images with distortion, mitigating distortion may reduce correspondence error and facilitate accurate correspondence determination the projection without distortion may bring significant error in finding correspondences. Thus, mitigating the effects of distortion may facilitate obtaining accurate correspondences. In some embodiments, knowledge of parameters associated with camera 110 on MS 100 may be used to determine the application and/or configuration of any anti-distortion techniques.

In some embodiments, inlier edge pixels may then be used for least squares fitting. In some embodiments, a sub-pixel edge location computation may be applied prior to least squares fitting, to get more accurate locations compared to integer position values. In some embodiments, the Hough transform steps above may yield one or two straight lines that correspond to the occluding contours 460 of exemplary cone section 400. The lines may be represented by 2D points xᵢ and normal direction nᵢ, where i=1, 2.

In some embodiments, RANdom SAmple Consensus (RANSAC) techniques may be used to select edges that represent the occluding contour. RANSAC is an iterative method to estimate parameters of a mathematical model using data sets, which may include outliers. In RANSAC, iterative techniques may be used obtain an optimal estimate of parameters based on data points determined to be inliers. Typically, in RANSAC, a set with the largest consensus set of “inlier” data points that meets error criteria relative to the mathematical model may be selected. For example, two points may be selected randomly and a line equation may be generated based on the two points. The equation may be used to determine inliers among the remaining points. The steps may be repeated with different point pairs to determine a line equation which gives the most inliers.

In some embodiments, using the 3D occluding contour determined in step 310, an exhaustive search for candidate edge pixels may be performed within a range R of points on the projected 2D occluding contour. Edge like refers to pixels with magnitude greater than some defined threshold R. In some embodiments, the threshold R may be defined empirically.

In some embodiments, segmentation-based methods may be used to separate the object region and the background region. For example, various methods such as Graph-Cut or level-set may be used for segmentation. Segmentation between the tracking object and the background may facilitate determination of the 2D projected occluding contours.

Referring to FIG. 3A, in step 325, the correspondences between the 3D occluding contour (from step 310) and the 2D occluding contour obtained in step 320 may be determined by obtaining the intersection of two lines: the 2D occluding contour found in step 320, and the normal direction line passing through X. The determined correspondences may be used to compute a Jacobian matrix relating the occluding contours to the camera pose. An exemplary computation of the Jacobian for exemplary 3D cone section 400 is described below. In general, the Jacobian may be computed for any smooth surface that may be represented by a closed form function.

In 3D tracking, the pose of the camera is estimated with respect to a world coordinate system. For example, inter-frame motion given by the rotation R and translation t may be estimated. Accordingly, for a camera whose pose is represented by pose [R, t], where R is the rotation matrix and t is the translation, the camera center may be written as

C=−R^{T}t (9)

When the camera undergoes a small motion, the pose update is [I+Ω, Δt], where I+Ω is a first order approximation to a rotation matrix and

$$Ω = [ \begin{matrix}0 & - {ω}_{z} & {ω}_{y} \\ {ω}_{z} & 0 & - {ω}_{x} \\ - {ω}_{y} & {ω}_{x} & 0\end{matrix} ] \qquad ( 10 )$$

is an antisymmetric matrix, Ω+Ω^{T}=0 and ω̅=[ωₓ,ω_{y},ω_{z}]^{T} is a 3D vector representing the direction of an axis of rotation and the magnitude of the vector is the magnitude of the rotation around the axis. Thus, the updated camera pose using compositional rule is

$$[ \begin{matrix}I + Ω & Δ t \\ 0 & 1\end{matrix} ] [ \begin{matrix}R & t \\ 0 & 1\end{matrix} ] = [ \begin{matrix}R + Ω R & t + Ω t + Δ t \\ 0 & 1\end{matrix} ] . \qquad ( 11 )$$

The updated camera center, up to the first order approximation, is

C′≈−[R^{T}+R^{T}Ω^{T}][t+Ωt+Δt] (12)

C′≈C−r^{T}Ωt−R^{T}Δt−R^{T}Ω^{T}t (13)

and applying the anti-symmetry property Ω+Ω^{T}=0, to equation (13) above yields,

C′≈C−R^{T}Δt (14)

For a first order approximation, the camera center motion may be approximated a function of only the translation vector Δt. Thus, based on the above approximation the occluding contour motion may also be viewed as a function of only the translation vector Δt. In contrast to the 6-parameter Special Euclidean group (3) (SE(3)) the translation vector Δt has three parameters. Further, occluding contour updates are also linear in t. In mathematical terms,

$$\frac{\partial C}{\partial θ} = [ O , - {R}^{T} ] \qquad ( 15 )$$

where, θ=[ωₓ,ω_{y},ω_{z},tₓ,t_{y},t_{z}]^{T} is the SE(3) parameter vector and O is 3×3 all zero matrix.

Further, as the camera moves, the amount of movement of a point X on the object surface is characterized by the partial derivative of X with respect to SE(3) parameters θ. Using the chain rule, we have

$$\frac{\partial X}{\partial θ} = \frac{\partial X}{\partial C} \cdot \frac{\partial C}{\partial θ} \qquad ( 16 )$$

where

$$\frac{\partial C}{\partial θ}$$

is given by equation (15) above and

$$\frac{\partial X}{\partial C} = ( a + bz ) [ \begin{matrix}\frac{\partial cos {φ}_{i}}{\partial {C}_{x}} & \frac{\partial cos {φ}_{i}}{\partial {C}_{y}} & \frac{\partial cos {φ}_{i}}{\partial {C}_{z}} \\ \frac{\partial sin {φ}_{i}}{\partial {C}_{x}} & \frac{\partial sin {φ}_{i}}{\partial {C}_{y}} & \frac{\partial sin {φ}_{i}}{\partial {C}_{z}} \\ 0 & 0 & 0\end{matrix} ] . \qquad ( 17 )$$

Setting l=\sqrt{Cₓ²+C_{y}²−(a+C_{z}b)²} and noting that d²=Cₓ²+C₆² (from equation (6) above), yields

$$\begin{matrix}\frac{\partial cos {φ}_{i}}{\partial {C}_{x}} = - \frac{2 {C}_{x}}{{d}^{2}} cos {φ}_{i} + \frac{1}{{d}^{2}} ( ( a + {C}_{z} b ) ∓ \frac{{C}_{y} {C}_{x}}{l} ) & ( 18 ) \\ \frac{\partial cos {φ}_{i}}{\partial {C}_{y}} = - \frac{2 {C}_{y}}{{d}^{2}} cos {φ}_{i} ∓ \frac{1}{{d}^{2}} ( l + \frac{{C}_{y}^{2}}{l} ) & ( 19 ) \\ \frac{\partial cos {φ}_{i}}{\partial {C}_{z}} = \frac{1}{{d}^{2}} ( {C}_{x} b ∓ \frac{- {C}_{y} ( a + {C}_{z} b ) b}{l} ) & ( 20 ) \\ \frac{\partial sin {φ}_{i}}{\partial {C}_{x}} = - \frac{2 {C}_{x}}{{d}^{2}} sin {φ}_{i} \pm \frac{1}{{d}^{2}} ( l + \frac{{C}_{x}^{2}}{l} ) & ( 21 ) \\ \frac{\partial sin {φ}_{i}}{\partial {C}_{y}} = - \frac{2 {C}_{y}}{{d}^{2}} sin {φ}_{i} + \frac{1}{{d}^{2}} ( ( a + {C}_{z} b ) \pm \frac{{C}_{y} {C}_{x}}{l} ) & ( 22 ) \\ \frac{\partial sin {φ}_{i}}{\partial {C}_{z}} = \frac{1}{{d}^{2}} ( {C}_{y} b \pm \frac{- {C}_{x} ( a + {C}_{z} b ) b}{l} ) & ( 23 )\end{matrix}$$

From the equations (18)-(23), we can see that for a given set of SE(3) parameters, the partial derivative can be computed and it has the form

$$\frac{\partial X}{\partial θ} = [ \begin{matrix}0 & 0 & 0 & {g}_{1} & {g}_{2} & {g}_{3} \\ 0 & 0 & 0 & {g}_{4} & {g}_{5} & {g}_{6} \\ 0 & 0 & 0 & 0 & 0 & 0\end{matrix} ] ≐ [ O , G ] \qquad ( 24 )$$

where G is the last three columns of the matrix representing the partial derivative

$$\frac{\partial X}{\partial θ} .$$

Thus, for a first order approximation, the occluding contour glides on the surface (tangent plane) as indicated by equation (25) below.

X(θ,Δθ)≈X(θ)+GΔt (25)

Further, from equations (11) and (25),

$${X}_{c} ( θ , Δθ ) \approx [ R + Ω R , t + Ω t + Δ t ] [ \begin{matrix}X ( θ ) + G Δ t \\ 1\end{matrix} ] . \qquad ( 26 )$$

Thus, from equation (26), the motion of a point on the occluding contour may be viewed as being composed of two parts. The first part [R+ΩR, t+Ωt+Δt] corresponds to the change in camera projection, while the second part

$$[ \begin{matrix}X ( θ ) + G Δ t \\ 1\end{matrix} ]$$

corresponds to the motion of the contour generator as a function of camera pose.

Further, by expanding equation (26) and ignoring second order and higher terms,

X_{c}(θ,Δθ)≈RX(θ)+t+Ω(RX(θ)+t)+(RG+I)Δt (27)

X_{c}(θ,Δθ)≈X_{c}(θ)+ΩX_{c}(θ)+(RG+I)Δt (28)

### Further, if

$$H ≐ RG + I ≐ [ \begin{matrix}{h}_{1} & {h}_{2} & {h}_{3} \\ {h}_{4} & {h}_{5} & {h}_{6} \\ {h}_{7} & {h}_{8} & {h}_{9}\end{matrix} ] , \qquad ( 29 )$$

then, equation 29 may be rewritten as

X_{c}(θ,Δθ)≈X_{c}(θ)+ΩX_{c}(θ)+HΔt (30)

For contour generators of conic sections, H is non-trivial. Equation (30) may be further broken down using components of X_{c}.

$$\{ \begin{matrix}{x}_{c}^{′} = {x}_{c} - {ω}_{z} {y}_{c} + {ω}_{y} {z}_{c} + {h}_{1} Δ {t}_{x} + {h}_{2} Δ {t}_{y} + {h}_{3} Δ {t}_{z} \\ {y}_{c}^{′} = {y}_{c} + {ω}_{z} {x}_{c} - {ω}_{x} {z}_{c} + {h}_{4} Δ {t}_{x} + {h}_{5} Δ {t}_{y} + {h}_{6} Δ {t}_{z} \\ {z}_{c}^{′} = {z}_{c} - {ω}_{y} {x}_{c} + {ω}_{x} {y}_{c} + {h}_{7} Δ {t}_{x} + {h}_{8} Δ {t}_{y} + {h}_{9} Δ {t}_{z}\end{matrix} \qquad ( 31 )$$

where (x′_{c},y′_{c},z′_{c}) and (x_{c},y_{c},z_{c}) are the x, y and z components of X_{c}(θ,Δθ) and X_{c}(θ), respectively, before and after applying the applying the delta composite motion implied by Δθ.

The projections of the contour generators form the occluding contours, therefore, using homogenous coordinates, where

$$\{ \begin{matrix}{u}^{′} = \frac{{x}_{{c}^{′}}}{{z}_{{c}^{′}}} \\ {v}^{′} = \frac{{y}_{{c}^{′}}}{{z}_{{c}^{′}}}\end{matrix} \qquad ( 32 )$$

and a first order approximation of the motion of (u′, v′) may be written as

$$[ \begin{matrix}{u}^{′} \\ {v}^{′}\end{matrix} ] \approx [ \begin{matrix}u \\ v\end{matrix} ] + J Δθ \qquad ( 33 )$$

where J is the Jacobian 2×6 matrix with

$$\frac{\partial {u}^{′}}{\partial θ} and \frac{\partial {v}^{′}}{\partial θ}$$

as rows of the matrix.

The components of J are given by

$$\begin{matrix}{J}_{11} = \frac{\partial {u}^{′}}{\partial {Δω}_{x}} = - \frac{{x}_{c} {y}_{c}}{{z}_{c}^{2}} & ( 34 ) \\ {J}_{12} = \frac{\partial {u}^{′}}{\partial {Δω}_{y}} = 1 + \frac{{x}_{c}^{2}}{{z}_{c}^{2}} & ( 35 ) \\ {J}_{13} = \frac{\partial {u}^{′}}{\partial {Δω}_{z}} = - \frac{{y}_{c}}{{z}_{c}} & ( 36 ) \\ {J}_{14} = \frac{\partial {u}^{′}}{\partial Δ {t}_{x}} = \frac{{h}_{1}}{{z}_{c}} - \frac{{h}_{7} {x}_{c}}{{z}_{c}^{2}} & ( 37 ) \\ {J}_{15} = \frac{\partial {u}^{′}}{\partial Δ {t}_{y}} = \frac{{h}_{2}}{{z}_{c}} - \frac{{h}_{8} {x}_{c}}{{z}_{c}^{2}} & ( 38 ) \\ {J}_{16} = \frac{\partial {u}^{′}}{\partial Δ {t}_{z}} = \frac{{h}_{3}}{{z}_{c}} - \frac{{h}_{9} {x}_{c}}{{z}_{c}^{2}} & ( 39 ) \\ {J}_{21} = \frac{\partial {v}^{′}}{\partial {Δω}_{x}} = - 1 - \frac{{y}_{c}^{2}}{{z}_{c}^{2}} & ( 40 ) \\ {J}_{22} = \frac{\partial {v}^{′}}{\partial {Δω}_{y}} = \frac{{x}_{c} {y}_{c}}{{z}_{c}^{2}} = - {J}_{11} & ( 41 ) \\ {J}_{23} = \frac{\partial {v}^{′}}{\partial {Δω}_{z}} = \frac{{x}_{c}}{{z}_{c}} & ( 42 ) \\ {J}_{24} = \frac{\partial {v}^{′}}{\partial Δ {t}_{x}} = \frac{{h}_{4}}{{z}_{c}} - \frac{{h}_{7} {y}_{c}}{{z}_{c}^{2}} & ( 43 ) \\ {J}_{25} = \frac{\partial {v}^{′}}{\partial Δ {t}_{y}} = \frac{{h}_{5}}{{z}_{c}} - \frac{{h}_{8} {y}_{c}}{{z}_{c}^{2}} & ( 44 ) \\ {J}_{26} = \frac{\partial {v}^{′}}{\partial Δ {t}_{z}} = \frac{{h}_{6}}{{z}_{c}} - \frac{{h}_{9} {y}_{c}}{{z}_{c}^{2}} & ( 45 )\end{matrix}$$

In step 325, equations (34)-(45) may be used to compute the Jacobian J for exemplary conical section 400. Equations (34)-(45) represent elements of the Jacobian of occluding contours as a function of the SE(3) parameters.

In general, a similar approach may be used to compute the Jacobian for a smooth surface representable by a closed form function. For example, the derivation may be extended using a surface function f(z). Conical section 400 may then be viewed as a special case for which f(z)=a+bz. For the surface function f(z), equation (2) above may be rewritten for the general case as

X(φ,z)=[f(z)cosφ, f(z)sinφ, z], z∈(z₀,z₁) (46),

so that the partial derivatives of X are given by

$$\{ \begin{matrix}{X}_{φ} = {f ( z ) [ - sin φ , cos φ , 0 ]}^{T} \\ {X}_{z} = {[ {f}^{′} ( z ) cos φ , {f}^{′} ( z ) sin φ , 1 ]}^{T}\end{matrix} . \qquad ( 47 )$$

and the corresponding normal is

$$n = {\frac{1}{\sqrt{1 + {{f}^{′} ( z )}^{2}}} [ cos φ , sin φ , - {f}^{′} ( z ) ]}^{T} . \qquad ( 48 )$$

Because the set of viewing rays X−C passing through the points X on the contour generator is perpendicular to the surface normal at X

$$[ cos φ , sin φ , - {f}^{′} ( z ) ] ( [ \begin{matrix}f ( z ) cos φ \\ f ( z ) sin φ \\ z\end{matrix} ] - [ \begin{matrix}{C}_{x} \\ {C}_{y} \\ {C}_{z}\end{matrix} ] ) = 0 , \qquad ( 49 )$$

which is equivalent to

f(z)−zf′(z)−(Cₓ cosφ+C_{y} sinφ−C_{z}f′(z))=0. (50)

### Further, if

$$θ = arctan ( \frac{{C}_{y}}{d} , \frac{{C}_{x}}{d} ) ,$$

and d=\sqrt{Cₓ²+C_{y}²} as in equations (5) and (6), above respectively, and

f_{z}=f(z)−zf′(z)+C_{z}f′(z), (51)

then

$$cos ( φ - θ ) = \frac{{f}_{z}}{d} , \qquad ( 52 )$$

and the constraints for the contour generator may be written as

$$φ = θ \pm arccos \frac{{f}_{z}}{d} , \qquad ( 53 )$$

which corresponds to the two polar angles given by

$${φ}_{1} = θ + arccos \frac{{f}_{z}}{d} and {φ}_{2} = θ - arccos \frac{{f}_{z}}{d} .$$

Accordingly, equation (53) can be rewritten as

[f(z)cosφᵢ, f(z)sinφᵢ,z], for i=1,2. (54)

### Further,

$$\{ \begin{matrix}cos {φ}_{i} = \frac{1}{{d}^{2}} ( {C}_{x} {f}_{z} ∓ {C}_{y} \sqrt{{d}^{2} - {f}_{z}^{2}} ) \\ sin {φ}_{i} = \frac{1}{{d}^{2}} ( {C}_{y} {f}_{z} \pm {C}_{x} \sqrt{{d}^{2} - {f}_{z}^{2}} )\end{matrix} , for i = 1 , 2. \qquad ( 55 )$$

Referring to FIG. 3A, for a tracked object whose occluding contour is representable as a closed form function and/or, may be derived from a closed form function, Equations (46) through (55) may be used in step 310 to generate the occluding contour. The closed form function may be used to model a more generic shape such as exemplary object 220 using a series of functions to represent 3D occluding contour.

Next, in step 315, as outlined earlier, the generated 3D occluding contour for the tracked object (from step 310 above) represented by the closed form function is projected on to the image plane. For example, based on the previous pose, and/or motion sensors, the 3D occluding contours may be projected onto the image plane to obtain the 2D projected occluding contour in the image plane.

In step 320, the 2D Occluding Contours in the image are determined. For example, as outlined above, edge detection or RANSAC may be used to determine the 2D occluding contour for the tracked object represented by the closed form function by searching for correspondences along the normal direction based on the visible projected points. For example, the 2D occluding contour may be determined from correspondences along the normal direction based on positions of visible projected points that yield the largest gradient magnitude. As another example, positions of visible projected points for which gradient magnitudes are greater than some threshold may be used to perform RANSAC-based fitting so that it can be similar with the projected f(z) contour.

In addition, for a tracked object with an occluding contour representable as or derived from a closed form function, as the camera moves, the amount of movement of a point X on the object surface is characterized by the partial derivative of X with respect to SE(3) parameters θ. Using the chain rule, from equation (16) we have

$$\frac{\partial X}{\partial θ} = \frac{\partial X}{\partial C} \cdot \frac{\partial C}{\partial θ} , where \frac{\partial C}{\partial θ}$$

is given by equation (15) above and

$$\frac{\partial X}{\partial C} = f ( z ) [ \begin{matrix}\frac{\partial cos {φ}_{i}}{\partial {C}_{x}} & \frac{\partial cos {φ}_{i}}{\partial {C}_{y}} & \frac{\partial cos {φ}_{i}}{\partial {C}_{z}} \\ \frac{\partial sin {φ}_{i}}{\partial {C}_{x}} & \frac{\partial sin {φ}_{i}}{\partial {C}_{y}} & \frac{\partial sin {φ}_{i}}{\partial {C}_{z}} \\ 0 & 0 & 0\end{matrix} ] . \qquad ( 56 )$$

Equation (56) may be used to derive the Jacobian of an occluding contour representable as a closed form function as a function of the SE(3) parameters, using equations (18) to (45).

In some embodiments, camera image frame 307 and estimated pose 309 from the previous frame and 3D model parameters may also be used by a conventional point and/or line tracker 340 to compute a Jacobian matrix 345 for a pose update. In feature-based tracking, 3D model features may be matched with features in a current image to estimate camera pose. For example, feature-based tracking may compare a current and prior image and/or the current image with one or more registered reference images to update and/or estimate camera pose. In general, the term 3D model is used herein to refer to a representation of a 3D environment being modeled by a device. In some embodiments, the 3D Model may take the form of a CAD model. In some embodiments, the 3D model may comprise a plurality of reference images. In some embodiments, point and/or line tracking step 340 may be performed concurrently with steps 310-325.

In step 330, Jacobian matrices from step 325 and 340 may be merged. The Jacobian in step 325, which provides the Jacobian of occluding contours as a function of the SE(3) parameters, may be used along with other features (blobs, points or line segments) for tracking the pose of the camera in 3D. Merging Jacobian matrices from steps 325 and 330 may help facilitate pose determination by using features such as points or lines on the objects' surface in addition to the Jacobian computed in step 325 for a smooth surface representable by a closed form function. Merging the Jacobians, which permits the use of features, facilitates pose determination, even in instances where the normal vectors to the 2D occluding contour (found in step 320) in the image plane are unidirectional, which may lead to a situation where the sampled points on the 2D occluding contour found in step 320 yields a single constraint for pose determination.

In some embodiments, the normal distance from a point on the contour generator to the corresponding observed occluding contour may be minimized by forming a linear constraint for each of the sampled point on each occluding contour. Mathematically, this may be expressed as

$${λ}_{OC} {n}_{i}^{T} ( [ \begin{matrix}u \\ v\end{matrix} ] + J Δθ - {x}_{i} ) = 0. \qquad ( 57 )$$

where λ_{OC} represents the weight assigned to the occluding contour.

In step 335, the pose may be updated based on the merged Jacobians in step 330. A solution for the pose update that brings all projections to the found correspondences may be obtained using equation (46) and with sufficient point and/or line correspondences.

If a point tracker is used in step 340, then equations (47)-(49) below may be used to compute the pose update.

(λₚHₚ+λ_{OC}H_{OC})Δθ=λₚb_{P}+λ_{OC}b_{OC} (58)

where

H_{P}=ΣJ_{P}^{T}J_{P} (59)

b_{P}=ΣJₚ^{T}Δuₚ (60)

where λ_{P} is the weight assigned to points, J_{P} represents Jacobian matrix 345, H_{OC} may be obtained from equation (29), and Δuₚ represents the difference in coordinates between the point correspondences in the image plane.

If a line tracker is used in step 340, then equations (49)-(51) below may be used to compute the pose update.

(λ_{L}H_{L}+λ_{OC}H_{OC})Δθ=λ_{L}b_{L}++λ_{OC}b_{OC} (61)

where

H_{L}Δθ=ΣJₗ^{T} nₗ·nₗ^{T} J₁ (62)

b_{L}=ΣJₗ^{T} nₗ·nₗ^{T} Δuₗ (63)

where λ_{L} is the weight assigned to lines, Jₗ represents Jacobian matrix 345, H_{OC} may be obtained from equation (29), Δu_{L} represents the difference in coordinates between the line correspondences in the image plane, and n=(nₓ n_{y})^{T} is a normal vector of u when u is projected onto the image plane. Further b_{OC} is given by equation (53) below as,

b_{OC}=ΣJ_{OC}^{T}n_{OC}·n_{OC}^{T}Δu_{OC} (64)

where λ_{OC} is the weights assigned to the occluding contour, J_{OC} represents Jacobian matrix for the occluding contour such as given by equations (34)-(45), and Δu_{OC} represents the difference in coordinates between the occluding contour correspondences in the image plane.

Method 300 may then return to step 310 to begin the next iteration. In some embodiments, the updated pose may be used render the tracked object.

FIG. 3D shows an application of a method for computing pose updates using occluding contours for object 220 that may be represented by a closed form function. As shown in FIG. 3D, the 3D occluding contour for a portion of exemplary object 220 may be modeled, for example, as a combination of four functions, where each function describes one of the conical sections 220-1, 220-2, 220-3 or 220-4. Further, in some embodiments, accurate tracking may be facilitated by tracking a plurality of feature points and/or edges 220-5 using a feature tracker in conjunction with the tracking of the occluding contour represented by the closed form function for object 220. Note that FIG. 3D illustrates one approach to representing the illustrated portion of object 220 by means of a closed form function. In general, object 220 may be represented using closed form function in various other ways.

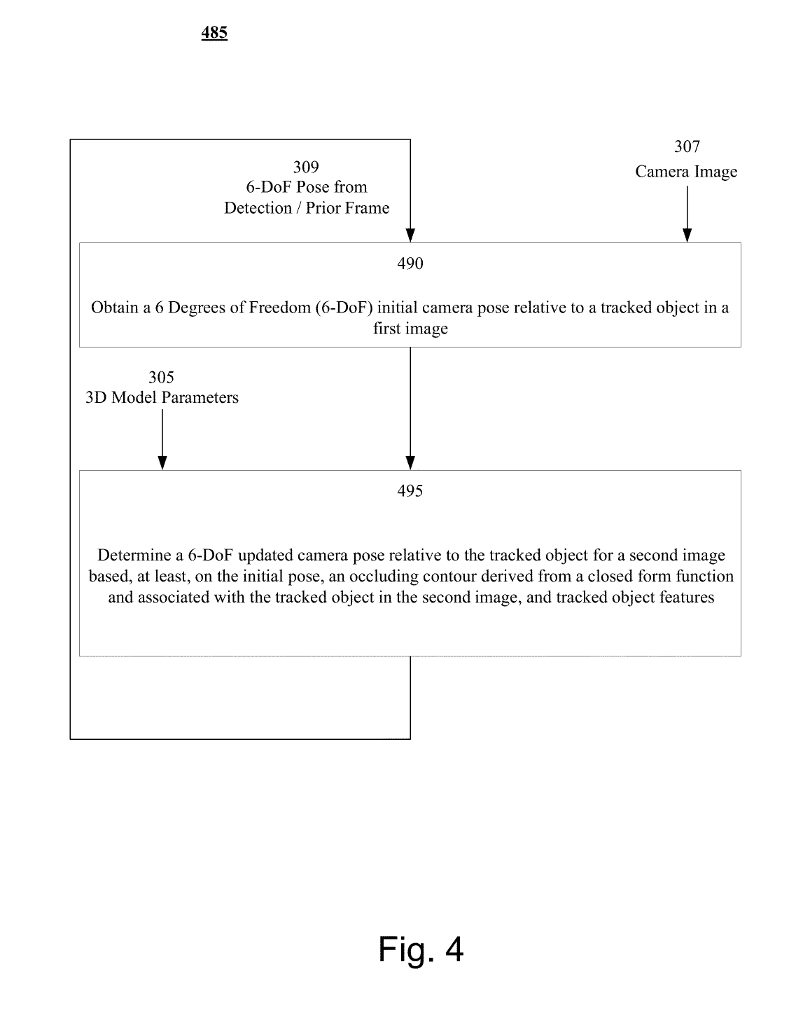

FIG. 4 shows a flowchart for an exemplary method 485 for computing pose updates using occluding contours. In step 490, a 6 Degrees of Freedom (6-DoF) initial camera pose relative to a tracked object in a first image may be obtained. In some embodiments, camera images 307 and a 6-DoF Pose from detection or a prior image frame (such as an immediately preceding frame) may be used as an estimate of the initial camera pose.

Next, in step 495, a 6-DoF updated camera pose relative to the tracked object for a second image subsequent to the first image may be determined. In some embodiments, the 6-DoF updated camera pose may be determined based, at least, on the initial camera pose, an occluding contour associated with the tracked object in the second image, and features associated with the tracked object. In some embodiments, the 6-DoF updated camera pose may be determined based, at least, on the initial camera pose and one or more of: (a) an occluding contour associated with the tracked object in the second image, wherein the occluding contour associated with the tracked object in the second image may be derived from a closed form function and (b) features associated with the tracked object. In some embodiments, 3D model parameters 305 may be input to step 395 and may be used in the computation of the occluding contour.

In some embodiments, method 480 may be performed by MS 100 using an image sequence captured by camera 110.

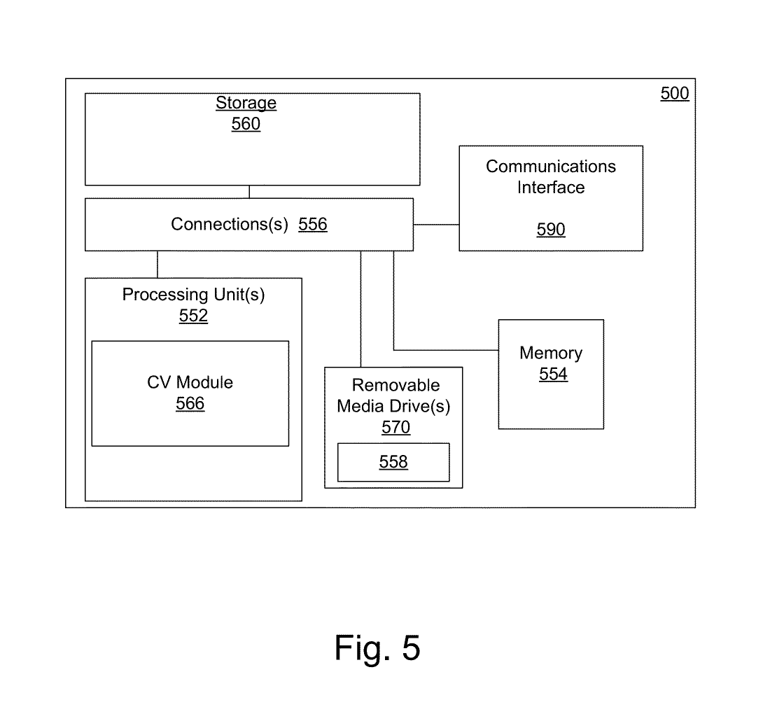

Reference is now made to FIG. 5, which is a schematic block diagram illustrating a computing device 500 enabled to facilitate the computation of pose updates using occluding contours in a manner consistent with disclosed embodiments. In some embodiments, computing device 500 may take the form of a server. In some embodiments, computing device 500 may include, for example, one or more processing units 552, memory 554, storage 560, and (as applicable) communications interface 590 (e.g., wireline or wireless network interface), which may be operatively coupled with one or more connections 556 (e.g., buses, lines, fibers, links, etc.). In certain example implementations, some portion of computing device 500 may take the form of a chipset, and/or the like. In some embodiments, computing device 500 may be wirelessly coupled to one or more MS′ 100 over a wireless network (not shown), which may one of a WWAN, WLAN or WPAN.

In some embodiments, computing device 500 may perform portions of the methods 300 and/or 485. In some embodiments, the above methods may be performed by processing units 552 and/or Computer Vision (CV) module 566. For example, the above methods may be performed in whole or in part by processing units 552 and/or CV module 566 in conjunction with one or more functional units on computing device 500 and/or in conjunction with MS 100. For example, computing device 500 may receive a sequence of captured images from MS 100 and may perform portions of one or more of methods 300 and/or 485 in whole, or in part, using CV module 566 and a 3D-model of the environment, which, in some instances, may be stored in memory 554.

Communications interface 590 may include a variety of wired and wireless connections that support wired transmission and/or reception and, if desired, may additionally or alternatively support transmission and reception of one or more signals over one or more types of wireless communication networks. Communications interface 590 may include interfaces for communication with MS 100 and/or various other computers and peripherals. For example, in one embodiment, communications interface 590 may comprise network interface cards, input-output cards, chips and/or ASICs that implement one or more of the communication functions performed by computing device 500. In some embodiments, communications interface 590 may also interface with MS 100 to send 3D model information, and/or receive images, data and/or instructions related to methods 300 and/or 485.

Processing units 552 may use some or all of the received information to perform the requested computations and/or to send the requested information and/or results to MS 100 via communications interface 590. In some embodiments, processing units 552 may be implemented using a combination of hardware, firmware, and software. In some embodiments, processing unit 552 may include CV Module 566, which may generate and/or process 3D models of the environment, perform 3D reconstruction, implement and execute various computer vision methods such as methods 300 and/or 485. In some embodiments, processing unit 552 may represent one or more circuits configurable to perform at least a portion of a data signal computing procedure or process related to the operation of computing device 500.

For example, CV module 566 may implement tracking based, in part, on the occluding contours of a tracked object, which may be derived from a closed form function. In some embodiments, CV module 566 may combine tracking based on occluding contours with feature-based tracking, which may use point and/or line features in a manner consistent with disclosed embodiments. In some embodiments, CV module 566 may perform one or more of image analysis, 3D model creation, feature extraction, target tracking, feature correspondence, camera pose determination using occluding contour and feature-tracking using point and/or line features. In some embodiments, one or more of the methods above may be invoked during the course of execution of various AR applications.

The methodologies described herein in flow charts and message flows may be implemented by various means depending upon the application. For example, these methodologies may be implemented in hardware, firmware, software, or any combination thereof. For a hardware implementation, the processing unit 552 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software may be stored in removable media drive 570, which may support the use of non-transitory computer-readable media 558, including removable media. Program code may be resident on non-transitory computer readable media 558 or memory 554 and may be read and executed by processing units 552. Memory may be implemented within processing units 552 or external to the processing units 552. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a non-transitory computer-readable medium 558 and/or memory 554. Examples include computer-readable media encoded with a data structure and computer-readable media encoded with a computer program. For example, non transitory computer-readable medium 558 including program code stored thereon may include program code to facilitate robust feature based tracking in a manner consistent with disclosed embodiments.

Computer-readable media may include a variety of physical computer storage media. A storage medium may be any available medium that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Other embodiments of computer readable media include flash drives, USB drives, solid state drives, memory cards, etc. Combinations of the above should also be included within the scope of computer-readable media.

In addition to storage on computer readable medium, instructions and/or data may be provided as signals on transmission media to communications interface 590, which may store the instructions/data in memory 554, storage 560 and/or relayed the instructions/data to processing units 552 for execution. For example, communications interface 590 may receive wireless or network signals indicative of instructions and data. The instructions and data are configured to cause one or more processors to implement the functions outlined in the claims. That is, the communication apparatus includes transmission media with signals indicative of information to perform disclosed functions.

Memory 554 may represent any data storage mechanism. Memory 554 may include, for example, a primary memory and/or a secondary memory. Primary memory may include, for example, a random access memory, read only memory, non-volatile RAM, etc. While illustrated in this example as being separate from processing unit 552, it should be understood that all or part of a primary memory may be provided within or otherwise co-located/coupled with processing unit 552. Secondary memory may include, for example, the same or similar type of memory as primary memory and/or storage 560 such as one or more data storage devices 560 including, for example, hard disk drives, optical disc drives, tape drives, a solid state memory drive, etc.

In some embodiments, storage 560 may comprise one or more databases that may hold information pertaining to an environment, including 3D models, images, databases and/or tables associated with stored models, keyframes, information pertaining to virtual objects, parameters associated with camera 110, look-up tables for image distortion correction, etc. In some embodiments, information in the databases may be read, used and/or updated by processing units 552 and/or CV module 566 during various computations.

In certain implementations, secondary memory may be operatively receptive of, or otherwise configurable to couple to a computer-readable medium 558. As such, in certain example implementations, the methods and/or apparatuses presented herein may be implemented in whole or in part using non transitory computer readable medium 558 that may include with computer implementable instructions stored thereon, which if executed by at least one processing unit 552 may be operatively enabled to perform all or portions of the example operations as described herein. In some embodiments, computer readable medium 558 may be read using removable media drive 570 and/or may form part of memory 554.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method comprising:
obtaining a 6 Degrees of Freedom (6-DoF) initial camera pose relative to a tracked object in a first image; and
determining a 6-DoF updated camera pose relative to the tracked object for a second image subsequent to the first image, the 6-DoF updated camera pose being determined based, at least, on the initial camera pose, an occluding contour associated with the tracked object in the second image and features associated with the tracked object, wherein the occluding contour associated with the tracked object in the second image is derived from a closed form function.

2. The method of claim 1, wherein the occluding contour in the second image is derived from the closed form function by:
generating a 3D occluding contour for the tracked object based on the closed form function;
projecting the 3D occluding contour for the tracked object onto an image plane associated with the second image based on the 6-DoF initial camera pose to obtain a projected 2D occluding contour;
detecting the occluding contour associated with the tracked object in the second image based, in part, on edge detection techniques in a region around the projected 2D occluding contour.

3. The method of claim 2, wherein the edge detection techniques comprise at least one of:
applying a Hough transform to detect edges around a plurality of points on the projected 2D occluding contour, the edges representing the occluding contour associated with the tracked object in the second image; or
applying Random Sample Consensus (RANSAC) to select edges that represent the occluding contour associated with the tracked object in the second image around a plurality of points on the projected 2D occluding contour.

4. The method of claim 2, further comprising:
determining the updated 6-DoF camera pose by merging a Jacobian matrix associated with the occluding contour and a Jacobian matrix associated with the tracked object.

5. The method of claim 4, wherein the Jacobian matrix associated with the occluding contour is determined based on correspondences between the occluding contour associated with the tracked object in the second image and the 3D occluding contour generated based on the closed form function.

6. The method of claim 2, wherein the first and second images are associated with respective first and second image pyramids and the edge detection techniques are applied across a hierarchy of images in the second image pyramid.

7. The method of claim 1, wherein a feature tracker is used to track features associated with the tracked object, wherein the feature tracker is one of:
an edge based tracker; or
a point based tracker.

8. The method of claim 1, wherein the 6-DoF updated camera pose is used, in part, to determine a 6-DoF starting camera pose for a third image subsequent and consecutive to the second image.

9. The method of claim 1, wherein the first and second images are consecutive images captured by the camera.

10. The method of claim 1, wherein the 6-DoF updated camera pose is used to render an Augmented Reality (AR) image.

11. A Mobile Station (MS) comprising:
a camera configured to capture a sequence of images comprising a first image and a second image captured subsequent to the first image; and
a processor coupled to the camera, the processor configured to
obtain a 6 Degrees of Freedom (6-DoF) initial camera pose relative to a tracked object in the first image, and
determine a 6-DoF updated camera pose relative to the tracked object for the second image, the 6-DoF updated camera pose being determined based, at least, on the initial camera pose, an occluding contour associated with the tracked object in the second image and features associated with the tracked object, wherein the occluding contour associated with the tracked object in the second image is derived from a closed form function.

12. The MS of claim 11, wherein to derive the occluding contour in the second image from the closed form function, the processor is further configured to:
generate a 3D occluding contour for the tracked object based on the closed form function;
project the 3D occluding contour for the tracked object onto an image plane associated with the second image based on the 6-DoF initial camera pose to obtain a projected 2D occluding contour;
detect the occluding contour associated with the tracked object in the second image based, in part, on edge detection in a region around the projected 2D occluding contour.

13. The MS of claim 12, wherein the edge detection comprises at least one of:
applying a Hough transform to detect edges around a plurality of points on the projected 2D occluding contour, the edges representing the occluding contour associated with the tracked object in the second image; or
applying Random Sample Consensus (RANSAC) to select edges that represent the occluding contour associated with the tracked object in the second image around a plurality of points on the projected 2D occluding contour.

14. The MS of claim 12, wherein the processor is further configured to:
determine the updated 6-DoF camera pose by merging a Jacobian matrix associated with the occluding contour and a Jacobian matrix associated with the tracked object.

15. The MS of claim 14, wherein the Jacobian matrix associated with the occluding contour is determined based on correspondences between the occluding contour associated with the tracked object in the second image and the 3D occluding contour generated based on the closed form function.

16. The MS of claim 12, wherein the first and second images are associated with respective first and second image pyramids and the edge detection techniques are applied across a hierarchy of images in the second image pyramid.

17. The MS of claim 11, wherein:
the processor is further configured to use a feature tracker to track features associated with the tracked object, and wherein the feature tracker is one of:
an edge based tracker; or
a point based tracker.

18. The MS of claim 11, wherein the processor is further configured to:
use the 6-DoF updated camera pose, at least in part, to determine a 6-DoF starting camera pose for a third image subsequent and consecutive to the second image.

19. The MS of claim 11, wherein the first and second images are consecutive images captured by the camera.

20. The MS of claim 11, further comprising:
a display coupled to the processor, wherein the 6-DoF updated camera pose is used to render an Augmented Reality (AR) image on the display.

21. An apparatus comprising:
means for obtaining a sequence of images comprising a first image and a second image captured subsequent to the first image;
means for obtaining a 6 Degrees of Freedom (6-DoF) initial camera pose relative to a tracked object in the first image, and
means for determining a 6-DoF updated camera pose relative to the tracked object for the second image, the 6-DoF updated camera pose being determined based, at least, on the initial camera pose, an occluding contour associated with the tracked object in the second image, and features associated with the tracked object, wherein the occluding contour associated with the tracked object in the second image is derived from a closed form function.

22. A non-transitory computer-readable medium comprising instructions, which when executed by a processor, perform steps in a method, the steps comprising:
obtaining a 6 Degrees of Freedom (6-DoF) initial camera pose relative to a tracked object in a first image; and
determining a 6-DoF updated camera pose relative to the tracked object for a second image subsequent to the first image, the 6-DoF updated camera pose being determined based, at least, on the initial camera pose, an occluding contour associated with the tracked object in the second image and features associated with the tracked object, wherein the occluding contour associated with the tracked object in the second image is derived from a closed form function.

23. The computer-readable medium of claim 22, wherein the occluding contour in the second image is derived from the closed form function by:
generating a 3D occluding contour for the tracked object based on the closed form function;
projecting the 3D occluding contour for the tracked object onto an image plane associated with the second image based on the 6-DoF initial camera pose to obtain a projected 2D occluding contour;
detecting the occluding contour associated with the tracked object in the second image based, in part, on edge detection techniques in a region around the projected 2D occluding contour.

24. The computer-readable medium of claim 23, wherein the edge detection techniques comprise at least one of:
applying a Hough transform to detect edges around a plurality of points on the projected 2D occluding contour, the edges representing the occluding contour associated with the tracked object in the second image; or
applying Random Sample Consensus (RANSAC) to select edges that represent the occluding contour associated with the tracked object in the second image.

25. The computer-readable medium of claim 23, the steps further comprising:
determining the updated 6-Dof camera pose by merging a Jacobian matrix associated with the occluding contour and a Jacobian matrix associated with the tracked object.

26. The computer-readable medium of claim 25, wherein the Jacobian matrix associated with the occluding contour is determined based on correspondences between the occluding contour associated with the tracked object in the second image and the 3D occluding contour generated based on the closed form function.

27. The computer-readable medium of claim 23, wherein the first and second images are associated with respective first and second image pyramids and the edge detection techniques are applied across a hierarchy of images in the second image pyramid.

28. The computer-readable medium of claim 22, wherein a feature tracker is used to track features associated with the tracked object, wherein the feature tracker is one of
an edge based tracker; or
a point based tracker.

29. The computer-readable medium of claim 22, wherein the 6-DoF updated camera pose is used, in part, to determine a 6-DoF starting camera pose for a third image subsequent and consecutive to the second image.

30. The computer-readable medium of claim 22, wherein the first and second images are consecutive images captured by the camera.
